(19) United States
(12) Patent Application Publication
(10) Pub. No.: US 2014/0071556 A1
(43) Pub. Date: Mar. 13, 2014

(54) FLEXIBLE COLOR FILTER SUBSTRATE USING PHASE CHANGE INK AND METHOD FOR MANUFACTURING THE SAME

(71) Applicant: L G CHEM, LTD., Seoul (KR)

(72) Inventors: Yong-Sung Goo, Daejeon (KR); Joon-Hyung Kim, Daejeon (KR)

(73) Assignee: LG CHEM, LTD., Seoul (KR)

(21) Appl. No.: 14/114,136

(22) PCT Filed: Jul. 25, 2013
(86) PCT No.: PCT/KR2013/006692

§ 371 Date: Oct. 25, 2013

(30) Foreign Application Priority Data
Jul. 25, 2012 (KR) 10-2012-0081224
Jul. 24, 2013 (KR) 10-2013-0087666

(51) Int. Cl. G02B 5/22

(52) U.S. Cl. CPC G02B 5/223
USPC 359/891; 427/162; 427/559

(57) ABSTRACT

There are provided a flexible color filter substrate and a method for manufacturing the same, the flexible color filter substrate including: a flexible substrate and R, G, and B patterns formed on the flexible substrate, wherein the R, G, and B patterns are formed using a phase change ink composition.

### TECHNICAL FIELD

The present invention relates to a flexible color filter substrate and a method for manufacturing the same, and more specifically, to a flexible color filter substrate capable of being used in a continuous process, without a black matrix, and a method for manufacturing the same.

### BACKGROUND ART

A fine pattern of a color filter according to the related art, such as a RGB pattern, has mainly been manufactured using a photolithography method. However, in the photolithography method, since a pattern is formed by coating the overall area with a photoresist, selectively exposing the pattern using a photomask, and developing a pattern-undesired portion to remove the portion, an amount of unnecessarily consumed materials may be relatively high, and a multiple-stage process may be required, leading to increased manufacturing costs, thereby lengthening a required manufacturing time.

Meanwhile, while interest in flexible displays has been rapidly increasing, research into replacing glass with plastic, as a substrate material of a display device, has been actively ongoing. When a glass substrate is substituted with a plastic substrate, the overall weight of the display device may be decreased while imparting flexibility to the design thereof. Moreover, in the case of a plastic substrate, impact resistance may be improved and manufacturing costs may be relatively low, due to the manufacturing thereof through a continuous process, as compared to the case of using a glass substrate.

However, the photolithography method described above may not be suitable to be used in a continuous process. Therefore, as a method of forming a color filter substrate in a flexible display, an inkjet method has been prominent as an alternative to the photolithography method.

However, in the case of a substrate used in flexible displays, surface energy of the substrate may be changed according to a manufacturing process and may have different values depending on a position of a substrate surface, such that surface energy of the substrate may be frequently irregular. In the case of an ink for forming a color filter used in an inkjet method according to the related art, it may be difficult to form a pattern having a uniform width and height on the substrate having irregular surface energy as described above. Moreover, in the inkjet method according to the related art, since a pattern may be formed using a solid substance left while an ink is dried, solvent volatilization may be generated in a non-uniform manner, such that a pattern surface may be uneven and may be formed in a concave or convex manner.

Furthermore, in the case of the ink for forming a color filter used in the related art, since flowability thereof may be high, R, G and B patterns may be easily mixed during a pattern formation process. Thus, in order to prevent the mixture, the related art method of forming a black matrix partition pattern and then filling the interior thereof with R, G and B inks, has been used. However, in such a method, a large number of processes may be required and inconvenience may be caused. In addition, in the case of the related art color filter formed using such a method, central portions and edge portions of the R, G and B patterns have different heights, such that an upper surface of the patterns may be formed unevenly. Such a phenomenon may be generated due to a difference in surface tension between a black matrix and an ink for forming a color filter. Although a slight deviation may be generated depending on types of ink used, in the case of a pixel pattern of a color filter substrate according to the related art, an arithmetic average roughness (Ra) of an upper surface may generally be 10% or more of a pixel pattern height. In this manner, when the upper pattern of the pixel pattern is uneven, uniform color may not be implemented.

Thus, the development of a color filter capable of being suitable for a continuous process and realizing a uniform line width and height of pattern portions, even at the time of applying the color filter to a plastic substrate, without a black matrix pattern being formed, has been demanded.

### DISCLOSURE

### Technical Problem

An aspect of the present invention provides a flexible color filter substrate suitable for a continuous process using a phase change ink and enabling a uniform pattern to be formed without a black matrix, and a method for manufacturing the same.

Aspects of the present invention are not limited thereto, and may be understood from the overall description of the specification. Additional aspects of the present invention could be understood by a person having ordinary skill in the art without difficulties.

### Technical Solution

According to an aspect of the present invention, there is provided a flexible color filter substrate, including: a flexible substrate; and R, G, and B patterns formed on the flexible substrate, wherein the R, G, and B patterns are formed using a phase change ink composition.

The flexible substrate may be formed of plastics, ultrathin glass, paper, thin metal fiber-reinforced plastics, or complexes thereof.

The phase change ink composition may have a melting point of about 50° C. to 120° C.

An upper surface of the R, G, and B patterns may have an arithmetic average roughness Ra equal to or less than 5% of a pattern height, preferably, about 0.1 to 5%. The R, G, and B patterns may have a ratio of a width to a height thereof, ranging from about 1:20 to 1:200.

According to another aspect of the present invention, there is provided a method for manufacturing a flexible color filter substrate, the method including: discharging a phase change ink composition on a flexible substrate to form R, G, and B patterns; and pressurizing the R, G, and B patterns at a temperature of (a melting point of the phase change ink composition−20)° C. to (the melting point of the phase change ink composition+15)° C.

The flexible substrate may be unwound from a roll having the flexible substrate wound therearound.

The discharging may be performed at a temperature of (the melting point of the phase change ink composition+5)° C. to (the melting point of the phase change ink composition+75)° C.

The discharging may be performed at a temperature of 70° C. to 125° C.

The pressurizing may be performed under a pressure of 0.01 to 50 MPa.

The pressurizing may be performed by a pressure roll or a flat plate.

The pressurizing may be performed while the pressure roll and the substrate move at a relative speed of 1 to 100 m/s.

The method further include: stacking a protective sheet on an upper portion of the R, G and B patterns before the pressurizing of the patterns.

The method further include: fixing the pressurized R, G and B patterns.

The fixing of the patterns may be performed through photo-curing.

All of features of the invention are not described in the above-described objects. Various features of the present invention and advantages and effects obtained thereby will be understood in more detail with reference to the following concrete embodiments.

### Advantageous Effects

In a flexible color filter substrate and a method for manufacturing the same according to embodiments of the present invention, since R, G, and B patterns are formed using a phase change ink, it may not necessary to form a black matrix in order to prevent a color mixture between the R, G, and B patterns, such that a continuous process may be allowed and uniform and precise patterns may be manufactured through a simple process.

In addition, in the flexible color filter substrate according to the embodiment of the present invention, since a black matrix positioned on a lower portion of a pixel element according to the related art may not be present, step portions within the pixel element or between pixels may not be generated. Furthermore, non-filling areas within the pixel element may not be generated, thereby significantly reducing a light leakage phenomenon, thereby allowing for excellent optical properties.

Meanwhile, when the flexible color filter substrate is manufactured through the method described above, since a dot pitch, applied pressure or the like may be adjusted at the time of discharging the phase change ink composition to control a line width and height of the R, G, and B patterns, the flexible color filter substrate may be usefully applied to various display devices having different levels of resolution.

In addition, when the R, G, and B patterns are formed using the phase change ink composition, the dispersion of ink may be low to thereby facilitate the formation of a pattern having a narrow line width. Furthermore, the black matrix is not required, thus facilitating the formation of a color filter pattern having a relatively low height.

### DESCRIPTION OF DRAWINGS

FIG. 1 is a view illustrating a flexible color filter substrate according to an embodiment of the present invention.

FIG. 2 is a view illustrating a method for manufacturing a flexible color filter substrate according to an embodiment of the present invention.

FIG. 3 is optical images showing shapes of patterns formed in a flexible substrate after a phase change ink is discharged onto the substrate while a dot pitch is changed.

FIG. 4 is optical images showing shapes of the patterns after pressurizing the patterns of FIG. 3.

FIG. 5 is an image obtained by observing the patterns of FIG. 3C using a 3D viewer, while FIG. 6 shows a profile of a cut surface of the image of FIG. 5, cut in a Y axis direction.

FIG. 7 is an image obtained by observing the patterns of FIG. 4C using a 3D viewer, while FIG. 8 shows a profile of a cut surface of the image of FIG. 7, cut in the Y axis direction.

FIG. 9 is photographs illustrating test results of heat resistance with respect to color filter substrates according to Examples 1 and 4.

### DESCRIPTION OF REFERENCE NUMERAL

10: Phase change ink composition
20: Inkjet head
30: Flexible substrate
40: Pressure roll
50: Light irradiating device

### BEST MODE

Hereinafter, embodiments of the present invention will be described in greater detail.

In order to develop a technology capable of being used in a continuous process and forming uniform and precise color filter patterns, as a result of repeated research, the inventors of the invention found that the above-described objects may be achieved by manufacturing a color filter substrate using a phase change ink, to thereby complete the invention.

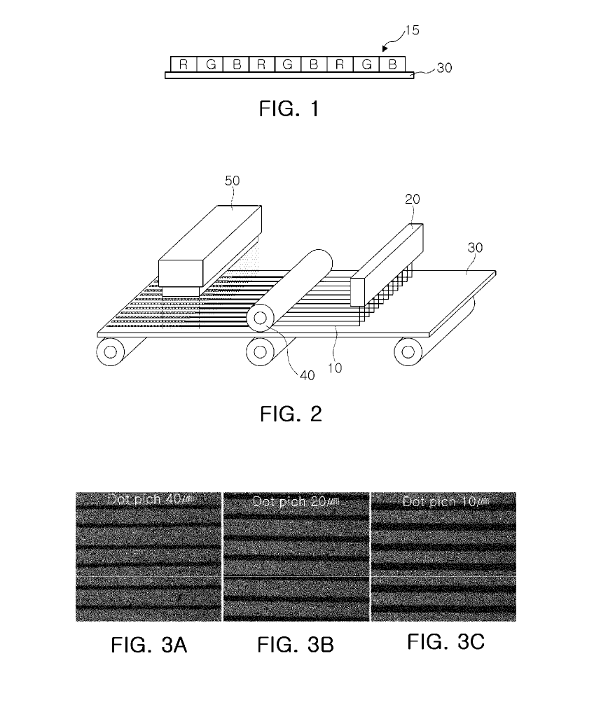

FIG. 1 is a view illustrating a flexible color filter substrate according to an embodiment of the present invention. As illustrated in FIG. 1, the flexible color filter substrate according to the embodiment of the present invention may include a flexible substrate 30 and R, G, and B patterns 15 formed on the flexible substrate. In this case, the R, G, and B patterns 15 may be formed using a phase change ink composition and a black matrix may not be formed between the R, G, and B patterns 15. Meanwhile, in the flexible color filter substrate according to the embodiment of the present invention, the R, G, and B patterns may be formed such that the respective pixel patterns are spaced apart from one another by predetermined distances and alternatively, the respective pixel patterns are adjacent to one another without intervals therebetween.

In the embodiment of the present invention, a material of the flexible substrate 30 is not particularly limited, as long as the substrate has flexibility. The flexible substrate 30 may be formed of, for example, plastics, ultrathin glass, paper, thin metal fiber-reinforced plastics, or complexes thereof, without limitation. Among these, the substrate may be formed of plastics in terms of lightness, flexibility of design, excellent impact resistance, and low manufacturing costs due to the manufacturing thereof through a continuous process.

Meanwhile, as the plastic substrate, a variety of plastic substrates formed of various materials and commonly used in the technical field may be used without limitation. For example, plastic substrates formed of polyethylene terephthalate (PET), polycarbonate, triacetyl cellulose (TAC), acryl, cycloolefin polymer (COP), polyethylene terephthalate (PET) treated with an acrylic primer, a polycarbonate film, a polynorbornene film, and the like, may be used.

However, as described above, in the case of the plastic substrate, it may be difficult to have a uniform surface energy according to process effects or materials thereof, leading to an inability to form uniform patterns using a color filter ink composition according to the related art. However, as in the present invention, when the R, G, B patterns are formed using the phase change ink composition, fine patterns having a uniform width may be formed on a surface of the substrate, regardless of surface energy.

A phase change ink may refer to an ink which is present in the form of a solid at room temperature, but may be converted into the form of a liquid at the operational temperature of an inkjet device, to be jetted in a liquid phase, thereby being adhered to a printing medium, and after the adhesion, is rapidly coagulated to form a pattern. In the case of using the phase change ink described above, since the ink is rapidly coagulated after being jetted onto the print medium, the ink is rarely diffused and accordingly, a color mixture of R, G, and B patterns may not be caused, even without a black matrix. Furthermore, since a coagulation speed of the ink may be controlled according to temperature, relatively uniform patterns may be formed, independently of a surface state of a substrate.

Meanwhile, the phase change ink composition usable in the embodiment of the present invention may include a phase change material and a colorant.

The phase change material may be provided to impart phase change properties to the ink, and is not limited but may be fatty acids, higher alcohols, and various types of wax, in the form of solids at room temperature. Specific examples of the phase change material may include, the fatty acids such as decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, heneicosanoic acid, docosanoic acid, tricosanoic acid, tetracosanoic acid, pentacosanoic acid, hexacosanoic acid, heptacosanoic acid, octacosanoic acid, nonacosanoic acid, triacontanoic acid, hentriacontanoic acid, dotriacontanoic acid, tritriacontanoic acid, tetratriacontanoic acid, pentatriacontanoic acid, and hexatriacontanoic acid; the higher alcohols such as decanol, undecanol, dodecanol, tridecanol, tetradecanol, pentadecanol, hexadecanol, heptadecanol, octadecanol, nonadecanol, eicosanol, heneicosanol, docosanol, tricosanol, tetracosanol, pentacosanol, hexacosanol, heptacosanol, octacosanol, nonacosanol, triacontanol, hentriacontanol, dotriacontanol, tritriacontanol, tetratriacontanol, pentatriacontanol, and hexatriacontanol; and the types of wax, such as wax derived from minerals, including paraffin wax, microcrystalline wax, barnsdall wax, ozokerite, ceresin, and montan wax, wax derived from plants, including carnauba wax, ouricury wax, candelilla wax, Japanese wax, and coconut butter, wax derived from animals, including beeswax and spermaceti, and synthetic wax including polyethylene wax, polyoxyethylene glycol wax, halogenated hydrocarbon wax, wax ester, and the like. However, the examples of the phase change material are not limited thereto.

Meanwhile, the phase change material may be included in an amount of about 3 to 95 parts by weight, preferably, in an amount of about 5 to 80 parts by weight or in an amount of about 5 to 50 parts by weight, with respect to the overall weight of the phase change ink composition. When the amount of the phase change material satisfies the range, effective phase change properties may be obtained, such that precise and uniform patterns may be formed.

Meanwhile, the colorant may be provided to impart color characteristics to the R, G, and B patterns and is not limited but may include at least one pigment or dye, or mixtures thereof. As the pigment, both of an inorganic pigment and an organic pigment may be used. Specific examples of the colorant may include carmine 6B (C.I.12490); phthalocyanine green (C.I. 74260); phthalocyanine blue (C.I. 74160); Victoria Pure Blue (C.I.42595); C.I. PIGMENT RED 3, 23, 97, 108, 122, 139, 140, 141, 142, 143, 144, 149, 166, 168, 175, 177, 180, 185, 189, 190, 192, 202, 214, 215, 220, 221, 224, 230, 235, 242, 254, 255, 260, 262, 264, 272; C.I. PIGMENT GREEN 7, 36; and C.I. PIGMENT blue 15:1, 15:3, 15:4, 15:6, 16, 22, 28, 36, 60, 64; and the like. Alternatively, other pigments and dyes known in the art may also be used.

The colorant may be included in an amount of about to 50 parts by weight, for example, in an amount of about 5 to 40 parts by weight or in an amount of about 5 to 30 parts by weight, with respect to the overall weight of the phase change ink composition. When the colorant is included in an amount greater 50 parts by weight, the dye may not be sufficiently dissolved, while the dispersion of the pigment may not be facilitated to result in an agglomeration of the phase change ink, greater than a size of a nozzle outlet, leading to an inability to perform a discharging process.

Meanwhile, the phase change ink composition according to the embodiment of the present invention may further include a polymer binder, as needed, and in this case, the polymer binder may be included in an amount of about 0 to 20 parts by weight, for example, in an amount of about 1 to 10 parts by weight or in an amount of about 3 to 5 parts by weight, with respect to the overall weight of the phase change ink composition. When the amount of the polymer binder is outside of the range, viscosity of the phase change ink in a liquid state may be increased to cause difficulties in a jetting process.

Meanwhile, the polymer binder is not limited but may be a homopolymer or copolymer resin of the following monomers. The monomers usable in the embodiment may be one or more selected from the group consisting of at least one unsaturated carboxylic acid ester monomer selected from a group consisting of benzyl (meth)acrylate, methyl (meth) acrylate, ethyl (meth)acrylate, butyl (meth)acrylate, dimethylaminoethyl (meth)acrylate, isobutyl (meth) acrylate, t-butyl (meth)acrylate, cyclohexyl (meth) acrylate, isobonyl (meth)acrylate, ethyl hexyl (meth) acrylate, 2-phenoxyethyl (meth)acrylate, tetrahydrofurfuryl (meth)acrylate, hydroxyethyl (meth) acrylate, 2-hydroxypropyl (meth)acrylate, 2-hydroxy-3-chloropropyl (meth)acrylate, 4-hydroxybutyl (meth) acrylate, acyloctyloxy-2-hydroxypropyl (meth)acrylate, glycerol (meth)acrylate, 2-methoxyethyl (meth)acrylate, 3-methoxybutyl (meth)acrylate, ethoxy diethylene glycol (meth)acrylate, methoxy triethylene glycol (meth) acrylate, methoxy tripropylene glycol (meth)acrylate, poly (ethylene glycol) methylether (meth)acrylate, phenoxy diethyleneglycol (meth)acrylate, p-nonylphenoxy polyethyleneglycol (meth)acrylate, p-nonylphenoxy polypropyleneglycol (meth)acrylate, glycidyl (meth) acrylate, tetrafluoropropyl (meth)acrylate, 1,1,1,3,3,3-hexafluoroisopropyl (meth)acrylate, octafluoropentyl (meth)acrylate, heptadecafluorodecyl (meth)acrylate, tribromophenyl (meth)acrylate, dicyclopentanyl (meth) acrylate, dicyclopentenyl (meth)acrylate, dicyclopentenyloxyethyl acrylate, isobonyl (meth)acrylate, adamentyl (meth)acrylate, methyl α-hydroxymethyl acrylate, ethyl α-hydroxymethyl acrylate, propyl α-hydroxymethyl acrylate and butyl α-hydroxymethyl acrylate; at least one aromatic vinyl monomer selected from a group consisting of styrene, α-methyl styrene, (o,m,p)-vinyl toluene, (o,m,p)-methoxy styrene, and (o,m,p)-chlorostyrene; at least one unsaturated ether monomer selected from a group consisting of vinyl methylether, vinyl ethylether, and allyl glycidyl ether; at least one unsaturated imide monomer selected from a group consisting of N-phenyl maleimide, N-(4-chlorophenyl)maleimide, N-(4-hydroxyphenyl)maleimide, and N-cyclohexyl maleimide; and maleic anhydride monomers such as maleic anhydride and methyl maleic anhydride, but are not limited thereto.

Meanwhile, as needed, the phase change ink composition according to the embodiment of the present invention may further include a reactive monomer or oligomer, and in this case, the reactive monomer or oligomer may be included in an amount of about 0 to 90 parts by weight, for example, in an amount of about 2 to 60 parts by weight, in an amount of about 3 to 50 parts by weight, or in an amount of about 5 to 30 parts by weight, with respect to the overall weight of the phase change ink composition, but the amount thereof is not limited thereto.

In this case, the reactive monomer or oligomer may be a photocurable compound that may be cured by radioactive or electron rays, and may be a functional monomer or oligomer having an ethylenically unsaturated combination; a ring-opening polymerizable monomer or oligomer, or the like. More specifically, the reactive monomer or oligomer may be a compound including acrylic derivatives, bisphenol A derivatives, or an epoxy or oxetane group, for example. Specific examples of the reactive monomer or oligomer may include at least one monofunctional monomer selected from a group consisting of polyethylene glycol mono (meth)acrylate, polypropylene glycol mono (meth)acrylate, and phenoxyethyl (meth) acrylate; at least one polyfunctional monomer selected from a group consisting of polyethylene glycol (meth) acrylate, polypropylene glycol (meth)acrylate, trimethylolethane triacrylate, trimethylolpropane triacrylate, neopentyl glycol (meth)acrylate, pentaerythritol tetraacrylate, pentaerythritol triacrylate, dipentaerythritol pentaacrylate, and dipentaerythritol hexaacrylate; urethane polyfunctional acrylate such as U-324A, U15HA and U-4HA; epoxy acrylate and novolac epoxy acrylate of bisphenol A derivatives; epoxy group-containing ethylenically unsaturated monomers such as allyl glycidyl ether, glycidyl 5-norbornene-2-methyl-2-carboxylate (endo, exo mixture) 1,2-epoxy-5-hexene, 1,2-epoxy-9-decene, 3,4-glycidyl (meth)acrylate, glycidyl α-ethyl (meth)acrylate, glycidyl α-n-propyl (meth)acrylate, glycidyl α-n-butyl (meth)acrylate, 3,4-epoxy-butyl (meth) acrylate, 4,5-epoxypentyl (meth)acrylate, 5,6-epoxyheptyl (meth)acrylate, 6,7-epoxyheptyl α-ethyl acrylate and methyl glycidyl (meth)acrylate; an oxetane group-containing monofunctional oxetane such as 3-ethyl-3-(2-ethylhexyloxymethyl)oxetane; an aromatic group-containing monofunctional oxetane such as 3-ethyl-3-phenoxymethyl oxetane; 1,4-bis[(3-ethyloxetane-3-yl)methoxymethyl]benzene; 1,4-bis[(3-ethyloxetane-3-yl)methoxy]benzene; 1,3-bis[(3-ethyloxetane-3-yl)methoxy]benzene; 1,2-bis [(3-ethyloxetane-3-yl)methoxy]benzene; 4,4′-bis[(3-ethyloxetane-3-yl)methoxy]biphenyl; 2,2′-bis[(3-ethyloxetane-3-yl)methoxy]biphenyl; 3,3′,5,5′-tetramethyl-4,4′-bis[(3-ethyloxetane-3-yl)methoxy]biphenyl; 2,7-bis[(3-ethyloxetane-3-yl)methoxy]naphthalene; bis[4-{(3-ethyloxetane-3-yl)methoxy}phenyl]methane; bis[2-{(3-ethyloxetane-3-yl)methoxy}phenyl]methane; 2,2-bis[4-{(3-ethyloxetane-3-yl)methoxy}phenyl}propane; 3(4),8(9)-bis[(3-ethyloxetane-3-yl)methoxymethyl]tricyclodecane; 2,3-bis[(3-ethyloxetane-3-yl)methoxymethyl]norbornane; 1,1,1-tris[(3-ethyloxetane-3-yl)methoxymethyl]propane; 1-butoxy-2,2-bis[(3-ethyloxetane-3-yl)methoxymethyl]butane; 1,2-bis [{2-(3-ethyloxetane-3-yl)methoxy}ethylthio]ethane; bis [{4-(3-ethyloxetane-3-yl)methylthio}phenyl]sulfide; 1,6-bis[(3-ethyloxetane-3-yl)methoxy]-2,2,3,3,4,4,5,5-octafluorohexane; 3-[(3-ethyloxetane-3-yl)methoxy]propyltrimethoxysilane; 3-[(3-ethyloxetane-3-yl)methoxy]propyltriethoxysilane; and the like.

Meanwhile, as needed, the phase change ink composition according to the embodiment of the present invention may further include a photopolymerization initiator. When the photopolymerization initiator and the photocurable compound are included in the phase change ink composition, the R, G, and B patterns may be fixed through photo-curing, whereby the deformation of the patterns according to changes in temperature, after the formation of the patterns, may be prevented. The photopolymerization initiator is not limited but may be a radical or cationic photopolymerization initiator known in the art.

Examples of the radical photopolymerization initiator may include triazine compounds such as 2,4-trichloromethyl-(4′-methoxyphenyl)-6-triazine, 2,4-trichloromethyl-(4′-methoxystyryl)-6-triazine, 2,4-trichloromethyl-(fipronil)-6-triazine, 2,4-trichloromethyl-(3′,4′-dimethoxyphenyl)-6-triazine, 3-{4-[2,4-bis(trichloromethyl)-s-triazine-6-yl]phenylthio}propane acid, and the like; non-imidazole compounds such as 2,2′-bis(2-chlorophenyl)-4,4′,5,5′-tetraphenyl non-imidazole, 2,2′-bis(2,3-dichlorophenyl)-4,4′,5,5′-tetraphenyl non-imidazole, and the like; acetophenone-based compounds such as 2-hydroxy-2-methyl-1-phenylpropane-1-one, 1-(4-isopropylphenyl)-2-hydroxy-2-methylpropane-1-one, 4-(2-hydroxyethoxy)-phenyl (2-hydroxy)propyl ketone, 1-hydroxycyclohexyl phenyl ketone, benzoin methylether, benzoin ethylether, benzoin isobutyl ether, benzoin butyl ether, 2,2-dimethoxy-2-phenyl acetophenone, 2-methyl-(4-methylthiophenyl)-2-morpholino-1-propane-1-one, 2-benzyl-2-dimethylamino-1-(4-morpholinophenyl)-butane-1-one, and the like; benzophenone-based compounds such as benzophenone, 4,4′-bis(dimethylamino)benzophenone, 4,4′-bis(diethylamino)benzophenone, 2,4,6-trimethyl amino benzophenone, methyl-o-benzoyl benzoate, 3,3-dimethyl-4-methoxybenzophenone, 3,3′,4,4′-tetra(t-butyl peroxy carbonyl)benzophenone, and the like; fluorenone-based compounds such as 9-fluorenone, 2-chloro-9-fluorenone, 2-methyl-9-fluorenone, and the like; thioxanthone-based compounds such as thioxanthone, 2,4-diethyl thioxanthone, 2-chloro thioxanthone, 1-chloro-4-propyloxy thioxanthone, isopropyl thioxanthone, diisopropyl thioxanthone, and the like; xanthone-based compounds such as xanthone, 2-methyl xanthone and the like; anthraquinone-based compounds such as anthraquinone, 2-methyl anthraquinone, 2-ethytl anthraquinone, t-butyl anthraquinone, 2,6-dichloro-9,10-anthraquinone and the like; acridine-based compounds such as 9-phenyl acridine, 1,7-bis(9-acridinyl)heptane, 1,5-bis(9-acridinyl)pentane, 1,3-bis(9-acridinyl)propane and the like; dicarbonyl compounds such as 1,7,7-trimethyl-bicyclo[2,2,1]heptane-2,3-dione, 9,10-phenanthrenequinone and the like; phosphine oxide-based compounds such as 2,4,6-trimethylbenzoyl diphenyl phosphine oxide, bis(2,6-dimethoxybenzoyl)-2,4,4-trimethylpentyl phosphine oxide, bis(2,6-dichlorobenzoyl)propyl phosphine oxide and the like; amine-based compounds such as methyl 4-(dimethylamino)benzoate, ethyl-4-(dimethylamino)benzoate, 2-n-butoxyethyl 4-(dimethylamino)benzoate, 2,5-bis(4-diethylaminobenzal)cyclopentanone, 2,6-bis(4-diethylaminobenzal)cyclohexanone, 2,6-bis(4-diethylaminobenzyl)-4-methyl-cyclohexanone and the like; coumarin-based compounds such as 3,3′-carbonyl vinyl-7-(diethylamino)coumarin, 3-(2-benzothiazolyl)-7-(diethylamino)coumarin, 3-benzoyl-7-(diethylamino)coumarin, 3-benzoyl-7-methoxy-coumarin, 10,10′-carbonylbis[1,1,7,7-tetramethyl-2,3,6,7-tetrahydro-1H,5H,11H—Cl]benzopyrano[6,7,8-ij]-quinolizine-11-one, and the like; chalcone compounds such as 4-diethylamino chalcone, 4-azidebenzal acetophenone and the like; and 2-benzoylmethylene, 3-methyl-β-naphthothiazoline, or mixtures thereof.

In addition, examples of the cationic photopolymerization initiator may include onium salts such as an aromatic diazonium salt, an aromatic iodine aluminum salt, and an aromatic sulfonium salt, an iron-arene complex, and the like.

The photopolymerization initiator may be included in an amount of about 0 to 10 parts by weight, for example, in an amount of about 0.01 to 5 parts by weight or in an amount of about 0.1 to 3 parts by weight, with respect to the overall weight of the phase change ink composition. When the photopolymerization initiator is included in an amount of 10 parts by weight or less, instances of contamination of equipment and surroundings thereof caused by sublimation of the photopolymerization initiator at the time of heating the phase change ink may be decreased.

Meanwhile, according to efficiency of the photopolymerization initiator, a photocrosslinking sensitizer may be additionally used. Examples of the photocrosslinking sensitizer are not limited but may include benzophenone-based compounds such as benzophenone, 4,4′-bis(dimethylamino)benzophenone, 4,4′-bis(diethylamino)benzophenone, 2,4,6-trimethyl amino benzophenone, methyl-o-benzoyl benzoate, 3,3-dimethyl-4-methoxybenzophenone, 3,3′,4,4′-tetra(t-butyl peroxy carbonyl)benzophenone, and the like; fluorenone-based compounds such as 9-fluorenone, 2-chloro-9-fluorenone, 2-methyl-9-fluorenone, and the like; thioxanthone-based compounds such as thioxanthone, 2,4-diethyl thioxanthone, 2-chloro thioxanthone, 1-chloro-4-propyloxy thioxanthone, isopropyl thioxanthone, diisopropyl thioxanthone, and the like; xanthone-based compounds such as xanthone, 2-methyl xanthone and the like; anthraquinone-based compounds such as anthraquinone, 2-methyl anthraquinone, 2-ethytl anthraquinone, t-butyl anthraquinone, 2,6-dichloro-9,10-anthraquinone and the like; acridine-based compounds such as 9-phenyl acridine, 1,7-bis(9-acridinyl)heptane, 1,5-bis(9-acridinyl)pentane, 1,3-bis(9-acridinyl)propane and the like; dicarbonyl compounds such as 1,7,7-trimethyl-bicyclo[2,2,1]heptane-2,3-dione, 9,10-phenanthrenequinone and the like; phosphine oxide-based compounds such as 2,4,6-trimethylbenzoyl diphenyl phosphine oxide, bis(2,6-dimethoxybenzoyl)-2,4,4-trimethylpentyl phosphine oxide and the like; benzophenone-based compounds such as methyl-4-(dimethylamino)benzoate, ethyl-4-(dimethylamino)benzoate, 2-n-butoxyethyl-4-(dimethylamino)benzoate and the like; amino synergists such as 2,5-bis(4-diethylaminobenzal)cyclopentanone, 2,6-bis(4-diethylaminobenzal)cyclohexanone, 2,6-bis(4-diethylaminobenzal)-4-methyl-cyclopentanone and the like; coumarin-based compounds such as 3,3′-carbonyl vinyl-7-(diethylamino)coumarin, 3-(2-benzothiazolyl)-7-(diethylamino)coumarin, 3-benzoyl-7-(diethylamino)coumarin, 3-benzoyl-7-methoxy-coumarin, 10,10′-carbonylbis[1,1,7,7-tetramethyl-2,3,6,7-tetrahydro-1H,5H,11H—Cl]-benzopyrano[6,7,8-ij]-quinolizine-11-one, and the like; chalcone compounds such as 4-diethylamino chalcone, 4-azidebenzal acetophenone and the like; and 2-benzoylmethylene, or 3-methyl-β-naphthothiazoline.

The photocrosslinking sensitizer may be included in an amount of about 0 to 10 parts by weight, for example, in an amount of about 0.01 to 5 parts by weight or in an amount of about 0.1 to 3 parts by weight, with respect to the overall weight of the phase change ink composition.

Meanwhile, the phase change ink composition may further include a solvent in order to adjust viscosity of the phase change ink or adjust the amount of a solid substance which will form patterns. In this case, the amount of the solvent is not limited but the solvent may be included in an amount of about 0 to 60 parts by weight, for example, in an amount of about 0 to 50 parts by weight or in an amount of about 0 to 30 parts by weight, with respect to the overall weight of the phase change ink composition. When the solvent is included in an amount greater than 60 parts by weight, characteristics in which the shape of the phase change ink is fixed due to a phase change depending on temperature may not exhibited, and a phenomenon in which a fine agglomeration of the phase change material is suspended in the solvent may be generated.

Meanwhile, examples of the solvent are not limited but may include methyl-3-methoxy propionate (having a boiling point 144° C., hereinafter, boiling points are indicated in parentheses), ethylene glycol methylether (125° C.), ethylene glycol ethylether (135° C.), ethylene glycol diethylether (121° C.), isopropyl monoethylene glycol (143° C.), dibutylether (140° C.), ethyl pyruvate (144° C.), propylene glycol methylether (121° C.), n-butyl acetate (125° C.), isobutyl acetate (116° C.), isoamyl acetate (143° C.), ethyl butyrate (120° C.), propyl butyrate (143° C.), methyl lactate (145° C.), methyl-2-hydroxyisobutyrate (137° C.), 2-methoxyethyl acetate (145° C.), ethylene glycol methylether acetate (145° C.), dibutyl ether (140° C.), cyclopentanone (131° C.), 2-hexanone (127° C.), 3-hexanone (123° C.), 5-methyl-2-hexanone (145° C.), 4-heptanone (145° C.), 1-methoxy-2-propanol (118° C.) 2-ethoxyethylether (185° C.), dipropylene glycol methylether (188° C.), 3-nonanone (188° C.), 5-nonanone (187° C.), 2,2,6-trimethylcyclohexanone (179° C.), cycloheptanone (179° C.), amyl butyrate (185° C.), butyl lactate (186° C.), ethyl-3-hydroxy butyrate (180° C.), propylene glycol diacetate (186° C.), dipropylene glycol methylether (188° C.), diethylene glycol methyl ethylether (176° C.), diethylene glycol methyl isopropyl ether (179° C.), diethylene glycol diethylether (189° C.), diethylene glycol monomethylether (194° C.), 4-ethylcyclohexanone (193° C.), 2-butoxyethylacetate (192° C.), diethylene glycol monoethylether (202° C.), butyrolactone (204° C.), hexylbutyrate (205° C.), diethylene glycol methylether acetate (209° C.), diethylene glycol butyl methylether (212° C.), tripropyl glycol dimethyl ether (215° C.), triethylene glycol dimethyl ether (216° C.), diethylene glycol ethylether acetate (217° C.), diethylene glycol butyl ether acetate (245° C.), 3-epoxy-1,2-propanediol (222° C.), ethyl-4-acetyl butyrate (222° C.), diethylene glycol monobutyl ether (231° C.), tripropyl glycol methylether (242° C.), diethylene glycol (245° C.), 2-(2-butoxyethoxy)ethyl acetate (245° C.), catechol (245° C.), triethylene glycol methylether (249° C.), and the like. More preferably, the solvent may have a boiling point temperature higher than a phase change temperature of the phase change material added in the phase change ink, by an amount equal to 5° C. or more.

Meanwhile, if necessary, the phase change ink composition according to the embodiment of the present invention may further include at least one additive selected from a group consisting of a dispersant, an adhesion promoter, an antioxidant, an ultraviolet ray absorbent, and a thermal polymerization inhibitor, in addition to the above-described components. In this case, the amount of the additive is not limited, but the additive may be included in an amount of about 0 to 10 parts by weight, for example, in an amount of about 1 to 8 parts by weight or in an amount of 1 to 5 parts by weight, with respect to the overall weight of the phase change ink composition. When the additive is included in an amount greater than 10 parts by weight, effects thereof may be insufficiently increased and manufacturing costs may be uneconomically increased.

Meanwhile, the adhesion promoter is not limited but may be, for example, at least one selected from a group consisting of vinyl trimethoxysilane, vinyl triethoxy silane, vinyltris(2-methoxyethoxy)-silane, N-(2-aminoethyl)-3-aminopropyl methyl dimethoxy silane, N-(2-aminoethyl)-3-aminopropyl methyl trimethoxy silane, 3-aminopropyl triethoxy silane, 3-glycidoxypropyl triethoxy silane, 3-glycidoxypropyl methyldimethoxy silane, 2-(3,4-ethoxy cyclohexyl)ethyl trimethoxy silane, 3-chloropropyl methyldimethoxy silane, 3-chloropropyl trimethoxy silane, 3-metaacryloxypropyl trimethoxy silane, and 3-mercaptopropyl trimethoxy silane.

In addition, the antioxidant is not limited but may be, for example, 2,2-thiobis(4-methyl-6-t-butylphenol), 2,6-g,t-butylphenol or the like. The ultraviolet ray absorbent is not limited but may be, for example, 2-(3-t-butyl-5-methyl-2-hydroxyphenyl)-5-chloro-benzotriazole, alkoxy benzophenone or the like. The thermal polymerization inhibitor is not limited but may be, for example, hydroquinone, p-methoxyphenol, di-t-butyl-p-cresol, pyrogallol, t-butylcatechol, benzoquinone, 4,4-thiobis(3-methyl-6-t-butylphenol), 2,2-methylenebis(4-methyl-6-t-butylphenol), 2-mercaptoimidazole or the like.

Meanwhile, the phase change ink composition according to the embodiment of the present invention may have a melting point of about 50° C. to 120° C. When the melting point of the phase change ink composition is outside the range, solidification of the ink may not be rapidly generated to cause pattern dispersion or lead to difficulties in a discharging operation.

Next, a method for manufacturing the flexible color filter substrate according to the embodiment of the present invention as described above may be described.

FIG. 2 is a view illustrating a method for manufacturing a flexible color filter substrate according to an embodiment of the present invention. As illustrated in FIG. 2, the method for manufacturing the flexible color filter substrate according to the embodiment of the present invention may include (1) discharging a phase change ink composition 10 onto the flexible substrate 30 to form R, G, and B patterns and (2) pressurizing the R, G, and B patterns at a temperature of (the melting point of the phase change ink composition−20)° C. to (the melting point of the phase change ink composition+15)° C.

In this case, a type of the flexible substrate, and compositions, the amount, and properties of the phase change ink composition may be the same as those described above, and thus, a detailed description thereof will be omitted.

First, phase change ink compositions respectively including a red colorant, a green colorant, and a blue colorant may be discharged onto the flexible substrate 30 to form R, G, and B patterns. In this case, as illustrated in FIG. 2, the flexible substrate 30 may be a substrate in a cut state, and may be unwound from a roll having the long flexible substrate wound therearound (not shown). The latter substrate may be further advantageous in that it may be applied to a continuous process, a roll to roll process.

Meanwhile, the discharging may be performed using a printhead or the like, of an inkjet printer. In order to discharge the phase change ink composition, since the ink composition needs to be in a liquid state, the printhead or the like of the inkjet printer may be heated to a temperature equal to or greater than the melting point of the phase change ink composition.

More specifically, the discharging may be performed at a temperature equal to or greater than the melting point of the phase change ink composition, for example, in a temperature range of (the melting point of the phase change ink composition+3)° C. to (the melting point of the phase change ink composition+85)° C., or (the melting point of the phase change ink composition+5)° C. to (the melting point of the phase change ink composition+75)° C. When the discharging is performed at a temperature lower than the melting point of the phase change ink composition, the phase change ink may not be completely dissolved and may remain in a solid state to thereby block a discharging part at the time of discharging the ink.

More preferably, the discharging may be performed in a temperature range of 50° C. to 160° C., for example, 60° C. to 140° C. or 70° C. to 125° C. The discharging temperature may be varied depending on the melting point of the phase change ink composition, a type of the discharging part, and the like, but in consideration of price benefits of devices, may be about 70° C. to 125° C.

Meanwhile, the discharged phase change ink composition may come into contact with the flexible substrate and may be rapidly solidified while losing heat due to surroundings thereof being at room temperature, to thereby form the R, G, and B patterns.

Then, the R, G, and B patterns may be pressurized. The pressurizing may be provided to improve flatness in a surface of the R, G and B patterns and may be performed at a temperature of (the melting point of the phase change ink composition−20)° C. to (the melting point of the phase change ink composition+15)° C.

The R, G and B patterns formed with the phase change ink composition may have a relatively uniform line width, but the surface thereof may be uneven and may be easily formed in a convex or concave manner due to differences in surface tension and solidification rates of the phase change ink compositions. However, when the surface of the R, G and B patterns is uneven, a concentration of the colorant may be varied depending on a position on the surface, to generate spots on a display screen. Therefore, in the embodiment of the present invention, the R, G and B patterns may be pressurized to improve flatness in the surface of the R, G and B patterns, thereby overcoming the defect.

Meanwhile, the pressurizing needs to be performed within a temperature and pressure range in which a structure of the R, G and B patterns formed using the phase change ink composition may not collapse while the surface form thereof may be flexibly adjusted.

Preferably, the pressurizing may be performed at a temperature of (the melting point of the phase change ink composition−20)° C. to (the melting point of the phase change ink composition+15)° C., for example, in a temperature range of (the melting point of the phase change ink composition−15)° C. to (the melting point of the phase change ink composition+10)° C. or (the melting point of the phase change ink composition−10)° C. to (the melting point of the phase change ink composition+5)° C. When the pressurizing temperature is outside of the numerical range, an insufficient amount of flexibility may be imparted to the patterns, such that the pattern surface thereof may be uneven, or an excessive amount of flexibility may be imparted to the patterns, such that the patterns structures may collapse, thereby leading to an inability to obtain patterns having desired shapes.

Meanwhile, the pressurizing is not limited but may be performed under a pressure of about 0.01 to 50 Mpa, for example, under a pressure of about 0.03 to 30 Mpa or a pressure of about 0.05 to 15 Mpa. In this case, the pressure may be appropriately adjusted depending on a width and height of patterns desired by a designer. However, in order to improve flatness and prevent a color mixture between the R, G and B patterns, it is necessary to satisfy the pressure range.

Meanwhile, the pressurizing may be performed by a method commonly known in the art and for example, may be performed by a pressure roll, a flat plate, or the like.

In the case of performing the pressurizing using a pressure roll 40, as illustrated in FIG. 2, the pressurizing may be performed while the pressure roll 40 and the flexible substrate 30 may move relatively with respect to each other. A relative speed between the pressure roll and the substrate may have a rate of 1 to 150 m/s, for example, a rate of 3 to 140 m/s, or a rate of 5 to 130 m/s. When the relative speed between the pressure roll and the substrate is outside of the numerical range, a processing process may be excessively slow, or a slight amount of vibrations may be generated below and on the substrate, such that precise patterns may not be formed.

Although not illustrated, the pressurizing may be performed by a flat plate and in this case, the pressurizing may be undertaken by a method of stacking the flat plate on the R, G and B patterns and pressing the same.

Meanwhile, the manufacturing method according to the embodiment of the present invention may further include stacking a protective film on an upper portion of the R, G and B patterns before the pressurizing of the patterns using the pressure roll or the flat plate. In the case in which the stacking of the protective film is additionally performed, the pressure roll or the flat plate may be prevented from being stained with the phase change ink composition, and the pressurizing may be undertaken in a further uniform manner. When the pressure roll or the flat plate is contaminated with the phase change ink composition, the next pattern may be affected by the phase change ink composition during the pressurizing thereof, to cause defects in continuous pattern formation.

Meanwhile, the method for manufacturing the flexible color filter substrate according to the embodiment may further include fixing the pressurized R, G and B patterns. The patterns formed using the phase change ink composition may be vulnerable to temperature changes since phases thereof may be varied depending on temperature. Thus, when the patterns are exposed to high temperature environments, the R, G and B patterns may be deformed to significantly degrade display functions. The fixing of the pressurized R, G and B patterns may be provided to solve the above defect. When the formation of a color filter is completed, the R, G, and B patterns may be cured and fixed by heat or light to prevent structures thereof from being deformed according to temperature changes.

In the embodiment of the present invention, the fixing may be performed through photo-curing. To this end, the phase change ink composition may further include the photocurable compound and the photopolymerization initiator. A specific description of the photocurable compound and the photopolymerization initiator addible in the composition is the same as that described above. In such a manner, when the phase change ink composition further includes the photocurable compound and the photopolymerization initiator, in a case in which ultraviolet rays are irradiated onto the patterns formed with the phase change ink composition, the patterns may be fixed in accordance with the curing of the photocurable compound, such that phase changes thereof may not be generated even in the case of an increase in temperature.

Meanwhile, the photo-curing is not particularly limited, but may be performed using a photo-curing method commonly known in the art. For example, as illustrated in FIG. 2, the photo-curing may be performed by a method of irradiating ultraviolet rays onto the R, G, and B patterns at an exposure amount of 10 mJ/cm² to 1000 mJ/cm² for about 1 to 100 seconds, using a light irradiating device 50.

In the flexible color filter substrate according to the embodiment of the present invention manufactured through the method as described above, the R, G, and B patterns may have a high degree of flatness in the upper surface thereof and may have a substantially rectangular cross-section. More specifically, in the flexible color filter substrate according to the embodiment of the present invention, the arithmetic average roughness Ra of the upper surface of the R, G, and B patterns may be equal to or less than 5%, preferably, may be about 0.1% to 5%, of a pattern height. In consideration of the fact that in the case of a color filter substrate manufactured using a general ink for manufacturing a color filter according to the related art, an arithmetic average roughness Ra of an upper surface of R, G, and B patterns is equal to or greater than 10% of a pattern height, it may be confirmed that in the case of the flexible color filter substrate according to the embodiment of the present invention, a high degree of flatness in a pixel pattern surface is exhibited. In the case of the flexible color filter substrate according to the embodiment of the present invention, the upper surface of pixel patterns may be even, such that uniform and clear color may be implemented at the time of applying the flexible color filter substrate to display devices.

Meanwhile, the arithmetic average roughness (Ra) refers to a value indicating a degree of unevenness on a surface, and may be calculated by obtaining the sum of areas surrounded by a curved line and a central line in a cross-section of a pattern to be measured and then dividing the summed value by a length of a measured section. The arithmetic average roughness Ra may be measured using a surface roughness measuring apparatus such as the trade name ALPHA-STEP, and a 3D viewer, which are commonly known in the art.

In the case of the flexible color filter substrate according to the embodiment of the present invention, since a black matrix positioned on a lower portion of a pixel element according to the related art may not be present, step portions within the pixel element or between pixels may not be generated. Furthermore, non-filling areas within the pixel element may not be generated, thereby significantly reducing a light leakage phenomenon, thereby allowing for excellent optical properties.

Meanwhile, when the flexible color filter substrate is manufactured through the method described above, since a dot pitch, applied pressure or the like may be adjusted at the time of discharging the phase change ink composition to control a line width and height of the R, G, and B patterns, the flexible color filter substrate may be usefully applied to various display devices having different levels of resolution. In addition, the line width of the R, G, and B patterns needs to be decreased in accordance with an increase in the resolution of display devices. Thus, as in the embodiment of the present invention, when the R, G, and B patterns are formed with the phase change ink composition, the dispersion of ink may be low to thereby facilitate the formation of a pattern having a narrow line width. Moreover, in accordance with a miniaturization of devices, there has recently been demand for a color filter pattern having a relatively low height. According to the embodiment of the present invention, the black matrix is not required, thus facilitating the formation of a color filter pattern having a relatively low height.

Meanwhile, in the embodiment of the present invention, respective color filter pixel patterns (that is, R, G, and B patterns) may have a width of about 30 μm to 200 μm, for example, a width of about 35 μm to 170 μm or a width of about 40 μm to 150 μm, but are not limited thereto.

Further, in the embodiment of the present invention, the respective color filter pixel patterns (that is, R, G, and B patterns) may have a height of about 1 μm to 10 μm, for example, a height of about 1 μm to 8 μm or a height of about 1 μm to 5 μm.

Furthermore, the respective patterns may have a ratio of a width to a height thereof ranging from about 1:20 to 1:200, for example, ranging from about 1:30 to 1:70 or ranging from about 1:40 to 1:70. When the ratio of a width to a height of the pattern is outside of this range, the formation of patterns may be unviable and the implementation of color on a display screen may be degraded.

### MODE FOR INVENTION

Hereinafter, the present invention will be described in detail with reference to concrete examples.

### Example 1

40 wt % of a red dye (Neozapon® red 395), 30 w % of trimethylolpropane triacrylate (TMTPA), 20 wt % of dipenta erythritol hexaacrylate (DPHA), and 10 w % of a phase change material (C₂₂OH) were mixed to manufacture a phase change ink composition having a melting point of 65° C.

After injecting the phase change ink composition into a reservoir, a temperature of the reservoir was set to 75° C., and jetting was performed through the entire 256 nozzles using a HM-30 printhead (by Dimatix. Inc., discharging amount 30 pl) with a voltage of 80V applied thereto. The jetting was undertaken on a PET film (by Lamiace Corp.) and during the jetting, a dot pitch was set to have an interval of 40 μm. After the jetting, linear patterns having a line width of about 50 μm on average and a height of 14 μm on average were formed. FIG. 3A illustrates a shape of the patterns formed after the jetting.

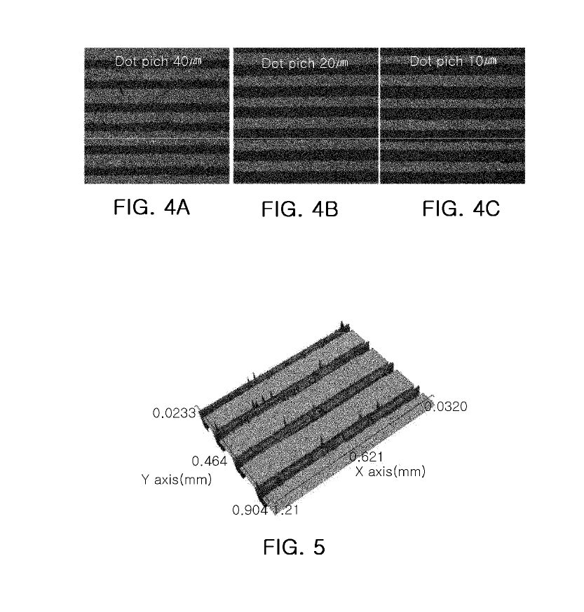

Next, the patterns were pressurized using a pressure roll under conditions of 60° C. and 0.1 MPa to planarize the patterns. FIG. 4A illustrates a shape of the patterns after the pressurization. It could be confirmed that the line width of the patterns was broadened after the pressurization, with reference to FIG. 3A and FIG. 4A. The line width and height of the patterns before and after the pressurization are described in the following [Table 1].

### Example 2

Jetting was performed in the same manner as that of Example 1, with the exception that the dot pitch was set to have an interval of 20 μm, such that linear patterns having a line width of about 70 μm on average and a height of 20 μm on average were formed. FIG. 3B illustrates a shape of the patterns formed after the jetting.

Next, the patterns were pressurized using a pressure roll under conditions of 60° C. and 0.1 MPa to planarize the patterns. FIG. 4B illustrates a shape of the patterns after the pressurization. It could be confirmed that the line width of the patterns was broadened after the pressurization, with reference to FIG. 3B and FIG. 4B. The line width and height of the patterns before and after the pressurization are described in the following [Table 1].

### Example 3

Jetting was performed in the same manner as that of Example 1, with the exception that the dot pitch was set to have an interval of 10 μm, such that linear patterns having a line width of about 90 μm on average and a height of 28 μm on average were formed. FIG. 3C illustrates a shape of the patterns formed after the jetting.

Next, the patterns were pressurized using a pressure roll under conditions of 60° C. and 0.1 MPa to planarize the patterns. FIG. 4C illustrates a shape of the patterns after the pressurization. It could be confirmed that the line width of the patterns was broadened after the pressurization, with reference to FIG. 3C and FIG. 4C. The line width and height of the patterns before and after the pressurization are described in the following [Table 1].

TABLE

| | | Before | | After | | | |
|---|---|---|---|---|---|---|---|
| | | Pressurization | | Pressurization | | | |
| | | Line | | Line | | | |
| | Dot Pitch | width | Height | width | Height | ΔW | ΔH |
| | (μm) | (W) | (H) | (W) | (H) | (μm) | (μm) |
| Example 1 | 40 | 46 | 14 | 100 | 4.5 | 54 | 7.5 |
| Example 2 | 20 | 70 | 20 | 130 | 9 | 60 | 11 |
| Example 3 | 10 | 90 | 28 | 150 | 12 | 60 | 16 |

Through FIG. 3, FIG. 4 and [Table 1], it could be confirmed that in the case in which patterns are formed using the phase change ink composition, as in the embodiment of the present invention, the dot pitch was controlled to thereby form patterns having various line widths and heights.

### Experimental Example 1

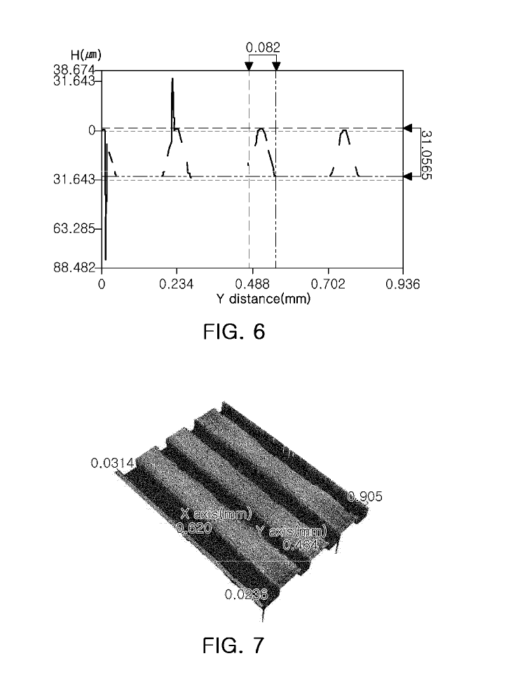

In order to determine changes in shapes of patterns before and after the pressurization, the shape of the patterns before and after the pressurization according to Example 3 was observed using a 3D viewer. FIG. 5 is an image of the patterns according to Example 3 before pressurization, that is, an image obtained by observing the patterns of FIG. 3C using the 3D viewer. FIG. 7 is an image of the patterns according to Example 3 after pressurization, that is, an image obtained by observing the patterns of FIG. 4C using the 3D viewer. FIG. 6 shows a profile of a cut surface of the image of FIG. 5, cut in a Y-axis direction. FIG. 8 shows a profile of a cut surface of the image of FIG. 7, cut in the Y axis direction.

With reference to FIGS. 5 through 8, it could be confirmed that a pattern shape was a bulged, mountain peak shape, immediately after forming pixel patterns using the phase change ink, such that the pixel patterns formed using the phase change ink were not suitable for pixel patterns, while after performing a pressurization process, a cross-sectional shape of the patterns had a substantially rectangular shape and the arithmetic average roughness of the upper surface thereof was approximately 0.5 μm, such that patterns having a significantly high degree of flatness were formed. In addition, it could be confirmed that the line width and height of the respective patterns were almost uniformly formed regardless of a position on the surface. This result shows that in the case of forming the color pixel patterns according to the embodiment of the present invention, pixel patterns having a uniform rectangular shape could be formed, even without black matrix partitions.

### Example 4

40 wt % of a red dye (Neozapon® red 395), 20 w % of trimethylolpropane triacrylate (TMTPA), 20 wt % of dipenta erythritol hexaacrylate (DPHA), 10 w % of a photopolymerization initiator (Igacure 907), and 10 w % of a phase change material (C₂₂OH) were mixed to manufacture a phase change ink composition having a melting point of 65° C.

After injecting the phase change ink composition into a reservoir, a temperature of the reservoir was set to 75° C., and jetting was performed through the entire 256 nozzles using a HM-30 printhead (by Dimatix. Inc., discharging amount 30 pl) with a voltage of 80V applied thereto. The jetting was undertaken on a PET film (by Lamiace Corp.) and during the jetting, a dot pitch was set to have an interval of 40 μm. After the jetting, linear patterns having a line width of about 45 μm on average and a height of 15 μm on average were formed.

Next, the patterns were pressurized using a pressure roll under conditions of 60° C. and 0.1 MPa to planarize the patterns.

Then, ultraviolet rays were irradiated onto the patterns at an exposure amount of 400 mW/cm² and 8 W for 2 to 3 seconds, using an UV hardening apparatus (by Phoseon Technology, Inc.) at a wavelength of 395 nm.

### Experimental Example 2

In order to determine differences in heat resistance properties depending on whether or not photo-curing is performed, color filter substrates manufactured according to Examples 1 and 4 were exposed to an oven at 80° C. for 1 minute, shapes of the pixel patterns were observed.

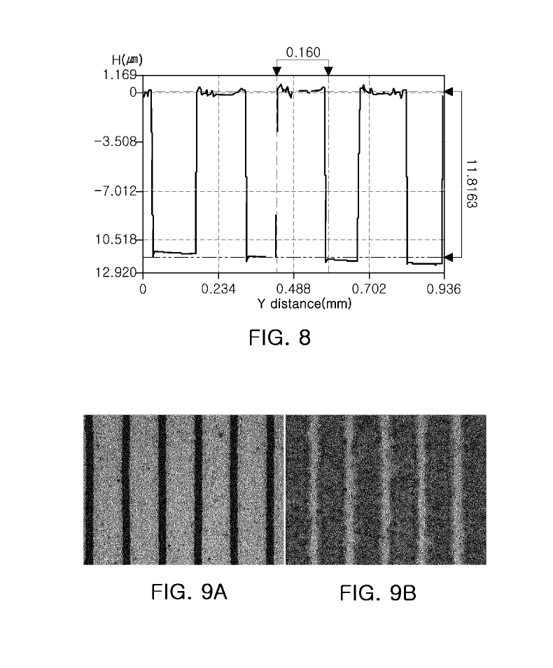

FIG. 9 is photographs illustrating shapes of the patterns after the color filter substrates according to Examples 1 and 4 are exposed to high temperatures. FIG. 9A is a photograph illustrating the shape of the patterns in the color filter substrate according to Example 4, and FIG. 9B is a photograph illustrating the shape of the patterns in the color filter substrate according to Example 1.

As illustrated in FIG. 9, in the case of the color filter substrate according to Example 1 which was not subjected to a pattern fixation process through photo-curing, the pattern shape was deformed after the exposure at high temperature. On the other hand, in the case of the color filter substrate according to Example 4 which was subjected to photo-curing, the pattern shape thereof was rarely changed even after the exposure at high temperature.

1. A flexible color filter substrate, comprising:
a flexible substrate and R, G, and B patterns formed on the flexible substrate,
wherein the R, G, and B patterns are formed using a phase change ink composition.

2. The flexible color filter substrate of claim 1, wherein the flexible substrate is formed of plastics, ultrathin glass, paper, thin metal fiber-reinforced plastics, or complexes thereof.

3. The flexible color filter substrate of claim 1, wherein the phase change ink composition has a melting point of 50° C. to 120° C.

4. The flexible color filter substrate of claim 1, wherein an upper surface of the R, G, and B patterns has an arithmetic average roughness equal to or less than 5% of a pattern height.

5. The flexible color filter substrate of claim 1 wherein the R, G, and B patterns have a ratio of a width to a height thereof, ranging from 1:20 to 1:200.

6. A method for manufacturing a flexible color filter substrate, the method comprising:
discharging a phase change ink composition on a flexible substrate to form R, G, and B patterns; and
pressurizing the R, G, and B patterns at a temperature of (a melting point of the phase change ink composition−20)° C. to (the melting point of the phase change ink composition+15)° C.

7. The method of claim 6, wherein the flexible substrate is unwound from a roll having the flexible substrate wound therearound.

8. The method of claim 6, wherein the discharging is performed at a temperature of (the melting point of the phase change ink composition+5)° C. to (the melting point of the phase change ink composition+75)° C.

9. The method of claim 6, wherein the discharging is performed at a temperature of 70° C. to 125° C.

10. The method of claim 6, wherein the pressurizing is performed under a pressure of 0.01 to 50 MPa.

11. The method of claim 6, wherein the pressurizing is performed by a pressure roll or a flat plate.

12. The method of claim 11, wherein the pressurizing is performed while the pressure roll and the substrate move at a relative speed of 1 to 100 m/s.

13. The method of claim 6, further comprising: stacking a protective sheet on an upper portion of the R, G and B patterns before the pressurizing of the patterns.

14. The method of claim 6, further comprising: fixing the pressurized R, G and B patterns.

15. The method of claim 14, wherein the fixing of the patterns is performed through photo-curing.
